(19) United States
(12) Patent Application Publication
(10) Pub. No.: US 2010/0153139 A1
(43) Pub. Date: Jun. 17, 2010

(54) SYSTEMS AND METHODS FOR ELECTRONICALLY REPORTING FINANCIAL INFORMATION AND NOTIFICATIONS

(75) Inventors: Dirk DeCanck, Alpharetta, GA (US); Steve Zalewski, Danville, CA (US); Ash Hassib, Acworth, GA (US)

Correspondence Address: TROUTMAN SANDERS LLP;5200 BANK OF AMERICA PLAZA, 600 PEACHTREE STREET, N.E., SUITE 5200, ATLANTA, GA, 30308-2216, US

(73) Assignee: Choicepoint Asset Company LLC, Alpharetta, GA (US)

(21) Appl. No.: 12/639,809

(22) Filed: Dec. 16, 2009

Related U.S. Application Data
(60) Provisional application No. 61/138,036, filed on Dec. 16, 2008.

(51) Int. Cl. G06Q 10/00; G06Q 30/00; G06Q 20/00; G06Q 40/00; G06Q 50/00

(52) U.S. Cl. 705/4; 705/34; 705/40; 705/30

(57) ABSTRACT

Systems and methods for reporting information to financial institutions and insurance carriers are disclosed. A reporting system can be a loss payee notification system comprising a communication device, a computer processor, a status update unit, and a bill management unit. The communication device can enable the reporting system to communicate with financial institutions and insurance carriers. The computer processor can provide various functions, including reconciling data received from the financial institutions and insurance carriers with data stored in a database. The status update unit can update the financial institutions of changed insurance information related to properties financed by the financial institutions and can also update the insurance carriers of changed loan information related to properties insured by the insurance carriers. The bill management unit can manage escrow bills to escrow accounts kept by the financial institutions. Other embodiments of the reporting system are also disclosed.

### CROSS-REFERENCE TO RELATED APPLICATIONS

This application claims a benefit, under 35 U.S.C. §119(e), of U.S. Provisional Application Ser. No. 61/138,036, filed 16 Dec. 2008, the entire contents and substance of which are hereby incorporated by reference.

### TECHNICAL FIELD

Various embodiments of the present invention relate to financial institution reporting systems and, more particularly, to reporting systems for providing escrow payments status, facilitating escrow payments, detecting and providing change in loan information, providing insurance policy status, processing tax bills, or a combination of these functions.

### BACKGROUND

When an insured property, such as real or personal property, is financed by a financial institution, that financial institution may be a loss payee when an insurance claim related to the property is paid. Because of the financial institution's interest in the property, the financial institution must remain apprised of details related to the property's insurance. Additionally, because the insurance carrier of the property also has an interest in the property, the financial institution and the insurance carrier must coordinate with each other in various instances.

Some financial institutions employ trackers to assist them in keeping track of insurance coverage of the various properties in which the financial institution has interests. A tracker ensures that the properties remain insured and reports insurance lapses to the financial institution. Unfortunately, insurance carriers are often unaware of trackers and continue attempt to interact directly with financial institutions, causing confusion. Additionally, trackers cannot share information between financial institutions, so financial institutions often fail to have complete, accurate information about insurance carriers and insurance policies.

The Financial Institution Reporting System (FIRSt) is an outsourced solution for producing and delivering lien-holder, mortgagee, and additional insured notices, such as loss payee notices. Customers of the FIRSt system can achieve substantial savings in their loss payee notification expenses by taking advantage of the economies of scale of the FIRSt system, while simultaneously reducing risk and increasing operational efficiency.

While an improvement over conventional methods, the FIRSt system did not previously provide a mechanism for financial institutions to receive updates related to insurance carriers, for insurance carriers to receive updates related to financial institutions, or for facilitating escrow payments related to insured properties.

Accordingly, there is a need for reporting systems and methods, such as an improved version of the FIRSt system, to streamline communications and status updates between financial institutions and insurance carriers and to facilitate various payments. It is to such reporting systems and methods that various embodiments of the present invention are directed.

### SUMMARY

Briefly described, various embodiments of the present invention are reporting systems and methods. Some exemplary embodiments of a reporting system according to the present invention can provide information updates to customers and can facilitate bill payments and reporting between customers. The reporting system can be a loss payee notification system that provides additional features to its customers. Customers of the reporting system can typically be financial institutions and insurance carriers who benefit from efficiently exchanging information regarding their interests in property.

Various embodiments of the reporting system can include enhancements made to the Financial Institution Reporting System (FIRSt), which is a loss payee notification system. The enhancements disclosed move FIRSt beyond a loss payee notification system by introducing additional services to enhance customer experience and interaction between customers. An exemplary enhanced reporting system according to the present invention can comprise a database and a server, where the server can include a status update unit and a bill management unit.

The database can maintain various data used by the reporting system in performing its reporting and payment functions. The database can be stored on the server or can be otherwise connected and accessible to the server.

The server can provide various functionalities of the reporting system, which can be implemented through one or more units operated on the server. These units can include the status update unit and the bill management unit.

The status update unit can notify customers when relevant information is updated in the reporting system. More specifically, the status update unit can notify financial institutions of changes in insurance coverage of properties financed by the financial institutions and can notify insurance carriers of loan changes related to properties insured by the insurance carriers. The status update unit can receive loan information from the financial institutions or their trackers and can also receive insurance coverage information from the insurance carriers. The received information can be reconciled with data related to loan information and insurance policies in the database, and as a result, current information on loans and insurance can be identified. The status update unit can then notify the customers of the identified updates.

The bill management unit can receive and manage escrow bills. For example, the bill management unit can receive escrow bills for insurance payments. The bill management unit can also receive status information on escrow accounts held by subscribing financial institutions and, in some instances, can receive funds from the financial institutions for payment of the escrow bills. Based on this information, the bill management unit can determine which escrow bills should be paid. Then, the bill management unit can reconcile the information in the bills to be paid with information in the database to ensure that payments are directed to the current insurance carriers. Finally, payments can be grouped based on recipient insurance carriers, so that an insurance carrier receives a bulk payment combining one or more escrow payments. The bill management unit can also transmit an electronic file to the insurance carriers to detail the contents of the bulk payments.

These and other objects, features, and advantages of the present invention will become more apparent upon reading the following specification in conjunction with the accompanying drawings.

### BRIEF DESCRIPTION OF THE FIGURES

FIG. 1 illustrates a diagram of a reporting system and various customers interacting with the reporting system, according to an exemplary embodiment of the present invention.

FIG. 2 illustrates a method of managing an escrow bill, according to an exemplary embodiment of the present invention.

### DETAILED DESCRIPTION

To facilitate an understanding of the principles and features of embodiments of the present invention, those principles and features are explained with reference to their implementation in illustrative embodiments. In particular, embodiments of the invention are described in the context of being financial institution reporting systems for reporting information and facilitating payments related to real property. Embodiments of the invention, however, are not limited to these specific embodiments of reporting systems. Rather, embodiments of the invention can relate to personal property, such as vehicles, or can report various matters to various types of entities.

The components described hereinafter as making up various elements of the invention are intended to be illustrative and not restrictive. Many suitable components that would perform the same or similar functions as the components described are intended to be embraced within the scope of the invention. Such other components can include, for example, components developed after development of the invention.

Referring now to the figures, in which like reference numerals represent like parts throughout the views, reporting systems and methods will be described in detail.

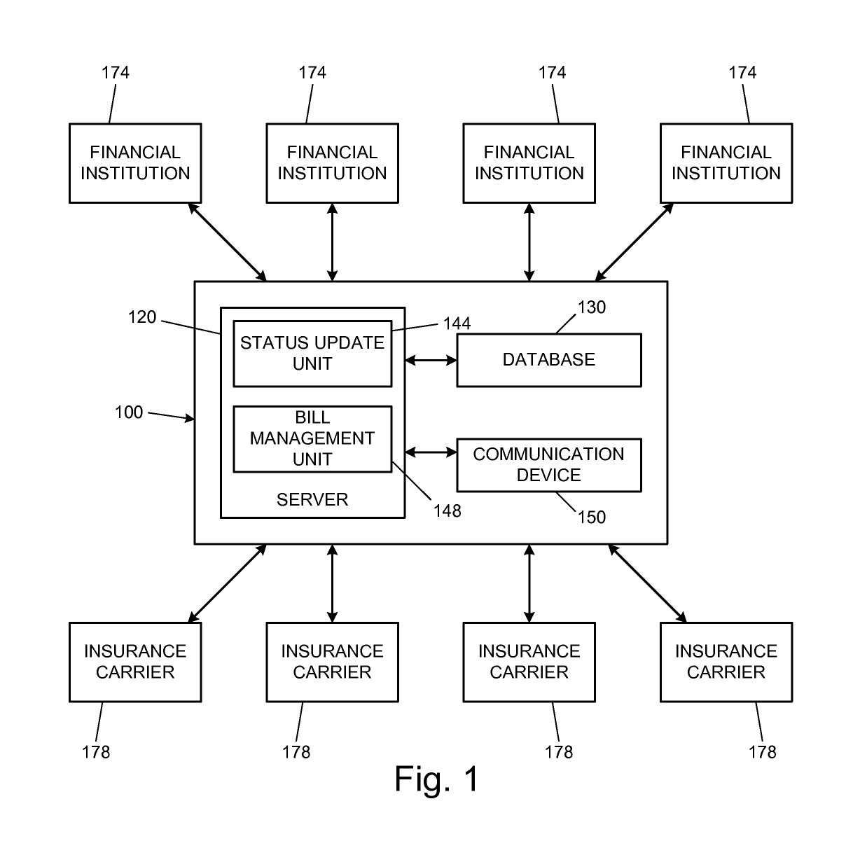

FIG. 1 illustrates a diagram of various elements of a reporting system, according to an exemplary embodiment of the present invention. As shown in FIG. 1, the reporting system 100 can comprise a server 120, a communication device 150, and a database 130, and the reporting system 100 can communicate with various customers, including financial institutions 174 and insurance carriers 178.

The server 120 can be one or more computing devices configured to provide various operations of the reporting system 100. Exemplary embodiments of the reporting system 100 can be described in a general context of computer-executable instructions, such as one or more applications or program modules executable by a computer. The computer-readable instructions can be stored on one or more computer-readable media on or associated with the server 120 and can be executed by one or more computer processing units on the on or associated with the server 120. Generally, program modules can include routines, programs, objects, components, or data structures that perform particular tasks or implement particular abstract data types. Embodiments of the reporting system 100 can also be practiced in distributed computing environments where tasks are performed by remote processing devices that are linked through a network. In a distributed computing environment, program modules can be located in both local and remote computer storage media and devices.

The server 120 can be one or more devices selected from various general purpose and special purpose computing devices and computing systems. For example, and not limitation, well-known computing systems, environments, and/or configurations that may be suitable for use with the reporting system 100 include personal computers, server computers, handheld or laptop devices, multiprocessor systems, microprocessor-based systems, set top boxes, programmable consumer electronics, network PCs, minicomputers, mainframe computers, distributed computing environments that include any of the above systems or devices, and the like.

Portions of computer-readable instructions on the server 120 can include, for example, instructions for implementing server-side processes of the reporting system 100. Such server-side processes can include processing requests from devices associated with the customer, as well as routing data from a first customer to a second customer. Additionally, if the reporting system 100 comprises one or more web application programs, the server 120 can support a website, through which the devices of the customers can communicate with the reporting system 100 via web clients.

The reporting system 100 can also include a communication device 150 for transmitting data over a network, such as the internet, to its customers. The communication device 150 can be on or otherwise connected to the server 130, such that results of operations performed by the server 120 can be communicated to the customers.

At least one database 130 can be provided in the reporting system 100 for maintaining data used by the reporting system 100. The database 130 can be of various types, such as a relational database or a simple text file, so long as it enables data access and searching by the server 120. The database 130 can be stored on a storage device located at the server 120 or otherwise accessible by the server 120, such as via a transfer cable, a local area network, or the internet.

As shown in FIG. 1, the reporting system 100 can be in communication with customers of the reporting system 100. These communications can be facilitated by the communication device 150. Customers of the reporting system 100 can include, for example, financial institutions 174 and insurance carriers 178. The reporting system 100 need not communicate directly with these end customers however. For example, a tracker can stand in the place of a financial institution 174 for interactions with the reporting system 100. Accordingly, although the term “financial institution” is used throughout the following description of the reporting system 100, a tracker can take the place of a financial institution 174 with respect to various aspects of the reporting system 100.

The arrows in FIG. 1 indicate how data and currency can flow into and out of the reporting system 100 and between components of the reporting system 100. For example, as shown in FIG. 1, data and currency can flow between the financial institutions 174 and the reporting system 100, and data and currency can flow between the insurance carriers 178 and the reporting system 100. Additionally, data can flow between the server 120 and the database 130.

In an exemplary embodiment of the reporting system 100, the reporting system 100 can provide an internet-based user interface, such as a web page, that can be accessed through automated operations at computing devices operated by the customers. As a result, some communications and payments facilitated by the reporting system 100 can occur automatically through system-to-system interactions. Additional details of the flows of information and currency between the reporting system 100 and its customers will be provided below. The reporting system 100 can provide various functionalities to its users. In some exemplary embodiments, for example, the server 120 or other components of the reporting system 100 can do the following: provide loss payee notification services between insurance carriers 178 and financial institutions 174, by providing loss payee notifications to financial institutions and trackers on behalf of the insurance carriers in accordance with state laws and regulations; cleanse lender names and addresses for notifications and payments by comparing the names and addresses of intended recipients to a database and modifying those names addresses before delivery of the notifications and payments to ensure accurate delivery; aggregate lender addresses; and process returned mail. In some exemplary embodiments, the reporting system 100 can also provide same-day service for one or more of its functionalities.

The server 120 can comprise one or more units for operation of various features of the reporting system 100. Such units can comprise modules, applications, devices, systems, services, or combinations or portions thereof. The units on the server 120 can include, for example, a status update unit 144 and a bill management unit 148.

Although the various units of the reporting system 100 are described below as distinct elements of the reporting system 100, this need not be the case. Rather, the various units are described in this manner only to clearly demonstrate various exemplary functionalities of the reporting system 100. In implementation, the units of the reporting system 100 can be combined together in whole or in part, such that components making up the units can be the same or overlapping components.

### Status Update Unit

The status update unit 144 can provide status updates to insurance carriers 178 and financial institutions 174. Through the status update unit 144, the reporting system 100 can keep insurance carriers 178 apprised of changes to loan information that might affect the carriers and can also keep financial institutions 174 apprised of insurance policy or carrier changes that might affect the financial institutions 174.

In general, the status update unit 144 can reconcile information received from insurance carriers 178, trackers, and financial institutions 174 with data already in the database 130 to determine the most up-to-date information on insurance policies and loans related to various properties. When applicable, the reporting system 100 can notify one or more financial institutions 174 or insurance carriers 178 of updated information that differs from the records of those financial institutions 174 and insurance carriers 178. In an exemplary embodiment, the notification can be transmitted from the server 120 of the reporting system 100 to a financial institution 174 or insurance carrier in the form of an electronic data interchange file (EDI) but other transmission formats can also be used.

On occasion, loan information for a property may change, such as when a financial institution 174 is purchased by another financial institution 174 or when the financial institution 174 transfers a loan on the property to another lender. Insurance carriers 178 must maintain current information on loans related to a properties insured by the carriers 178, so as to provide escrow bills and loss payee notifications to the correct financial institutions 174. Through conventional methods, information known by insurance carriers 178 can become out of date when loan information changes, because insurance carriers 178 are not normally notified of changes electronically, and it may be expensive to make potential updates to loan information.

The status update unit 144 can provide immediate, or otherwise efficient, electronic reconciliation of loan information, so as to maintain accurate loan records. In some situations, an insurance carrier 178 may submit an escrow bill or loss payee notification based on old or expired loan information. To rectify these situations, when an insurance carrier 178 submits an escrow bill or loss payee notification to the reporting system 100, the bill or notification can be compared to the database 130 in the reconciliation process. If, based on that comparison, the status update unit 144 determines that the escrow bill or notification is directed to an incorrect financial institution, the status update unit 144 can notify the insurance carrier of the correct loan information.

In some exemplary embodiments, the status update unit 144 can minimize the quantity of data transmissions by aggregating loan information updates based on their recipient insurance carriers 178. In other words, if the status update unit 144 determines that a particular insurance carrier should receive a loan information update regarding two distinct loans, then those two updates can be combined into a single transmission.

When an insurance carrier receives a loan information update, the insurance carrier can then update its records and policy administration accordingly. This can save the insurance carrier time and money by reducing or eliminating the legwork usually required for an insurance carrier to identify a change in a relevant loan and then to obtain the correct loan information. As a result of the status update unit 144, insurance carriers 178 can obtain changed loan information more efficiently and with fewer errors and manual telephone calls.

Financial institutions 174 also have a need for information updates, and the status update unit 144 can provide these updates in an efficient manner. Because a financial institution 174 may be a loss payee on an insurance policy for a property financed by that financial institution 174, the financial institution 174 would benefit from being informed about changes to that insurance policy. Additionally, because the financial institution 174 must make insurance payments from an escrow account, the financial institution 174 should ensure that it knows the correct recipient insurance carrier 178 for those payments.

Conventionally, when a cancellation or expiration data for the insurance policy approaches, the financial institution 174, possibly through a tracker, contacts the insurance carrier to determine whether coverage will be renewed or replaced. This conventional method is both time-consuming, requiring the time of human representatives of both the financial institution 174 and the insurance carrier, and also inefficient, given that these representatives likely have limited contact hours. Further, if the financial institution 174 determines that the insurance carrier will no longer cover the property, the financial institution 174 must then contact the borrower to determine whether valid insurance will be undertaken by a new insurance carrier. An exemplary embodiment of the status update unit 144 can reduce or eliminate this legwork conventionally performed by the financial institution 174 to obtain insurance updates.

In some embodiments, the reporting system 100 can access the full policy books of its participating insurance carriers 174, which information can be maintained in the database 130. As a result, the database 130 can maintain the current information on insurance policies held by the carriers, so that the status update unit 144 can determine exactly which insurance policies are currently covering a property tracked by the reporting system 100. An insurance record in the database 130 can include, for example, the carrier name, the policy status, the policy type, and the date of last update to the policy. These records can be updated based on data received from the insurance carriers 178 or individual borrowers. For example, a current carrier of insurance carrier for a policy can notify the reporting system 100 of whether and under what terms it will continue to insure the property. In some circumstances, such as when a policy will not be renewed, a new insurance carrier can indicate that it will carry the insurance for the property.

Based on these policy set contributions received from insurance carriers 178 and other parties, the reporting system 100 can update the database 130 to reflect the most current insurance statuses. If conflicting insurance information is discovered, the status update unit 144 can determine the most current information and can update the database 130 with that information. When a change in insurance information is discovered, the status update unit 144 can report the change to the relevant financial institution 174.

In some exemplary embodiments, the status update unit 144 can minimize the quantity of data transmissions by aggregating loan or insurance information updates based on their recipients. In other words, if the status update unit 144 determines that a particular insurance carrier should receive a loan information update regarding two distinct loans, then those two updates can be combined into a single transmission. Analogously, if the status update unit 144 determines that a particular financial institution 174 should receive an insurance status update regarding two distinct policies or properties, then those two updates can be combined into a single data transmission.

The status update unit 144 can reconcile data and send information updates according to various schedules depending on the desires of the customers (i.e., the financial institutions 174 and insurance carriers 178) or the operators of the reporting system 100. For example, in some embodiments, the status update unit 144 can continuously reconcile data and transmit updates in real time, as new data is received. Alternatively, the status update unit 144 can be scheduled to run periodically, so as to transmit updates at intervals. Further alternatively, the status update unit 144 can be customized to deliver information updates based on the indicated preferences of individual customers, such that a first customers loan information updates are transmitted based on different scheduling criteria than a second customer's loan information updates.

In some exemplary embodiments, the information updates identified by the status update unit 144 can be accessible to relevant parties via a web-based system. In that case, a financial institution 174 can log into the web-based system associated with the reporting system 100 can then view the insurance information updates.

### Bill Management Unit

The bill management unit 148 of the reporting system 100 can manage and pay escrow bills (i.e., bills to an escrow account) in a more efficient and accurate manner than possible by conventional methods. Financial institutions 174 typically do not notify insurance carriers 178 of expected nonpayment of escrow bills for paying on an insurance policy. Accordingly, when an escrow bill is past due, an insurance carrier may contact a financial institution 174 and, only then, become informed that the escrow bill payment will be delayed or will not occur. This costs both the insurance carrier and the financial institution 174 time and money. Through aspects of the bill management unit 148, the reporting system 100 can more effectively manage and pay escrow bills.

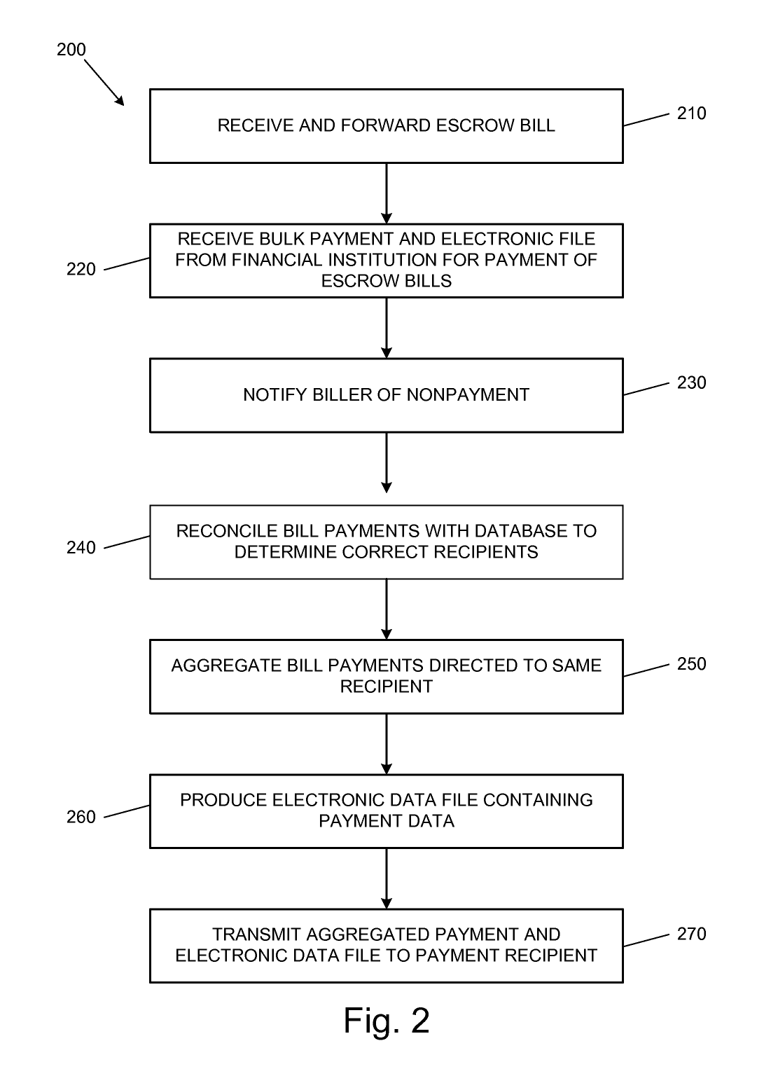

FIG. 2 illustrates a method of managing an escrow bill, according to an exemplary embodiment of the present invention.

The reporting system 100 can receive escrow bills from insurance carriers 178, as illustrates at 210 of FIG. 2, and can forward those bills to financial institutions 174 for payment. In an exemplary embodiment, the reporting system 100 receives electronic transmission of the escrow bills, but if a paper bill is received, a human associated with the reporting system 100 can manually enter the bill into the reporting system 100.

After receiving one or more escrow bills from various insurance carriers 178, a financial institution 174 can transmit funds for payment of the escrow bills to the reporting system 100. In an exemplary embodiment, the financial institution transmits a bulk payment, combining payments of one or multiple escrow bills. The payment transmission can be accompanied by, or associated with, and electronic file also transmitted to the reporting system 100 from the financial institution 174. The electronic file can indicate the escrow bills to be paid from the bulk payment.

At 220, the bill management unit 148 can receive the bulk payment and the electronic file. As a result of these funds and data received from financial institutions 174 related to escrow bills, the bill management unit 148 of the reporting system 100 can access data indicating what escrow bills are due and what funds have been received for payment of those escrow bills. Accordingly, using the electronic file, the bill management unit 148 can separate the individual escrow payments received in each bulk payment from a financial institution.

The bill management unit 148 of the reporting system 100 can electronically reconcile escrow bills and payments to enable insurance carriers 178 to proactively manage nonpayment situations without losing time and money. In the reconciliation process, as shown at 230, the bill management unit 148 can determine which escrow bills will remain unpaid and can notify the insurance carriers of nonpayment. Additionally, during reconciliation, as shown at 240, the bill management unit 148 can determine whether bills are being paid accurately. For each payment, the bill management unit 148 can compare the payment to the database 130 to determine whether the intended recipient of the payment is still the payee of record. In the case of recipient insurance carriers, for example, the bill management unit 148 can determine whether the intended recipient insurance carrier still carries the policy for the property in question. If not, the bill management system 148 can notify the financial institution of the change in policy. As a result, insurance carriers 178 are not paid for policies that they no longer carry.

At 250, the bill management unit 148 can group escrow bill payments based on their correct recipients, so that each recipient receives a combined payment including one or multiple escrow payments from one or multiple escrow accounts. At 260, the bill management unit 148 can also produce an electronic data file, such as an EDI file, to the insurance carriers 178 receiving payments to notify those carriers of the contents of the combined payment. At 270 of FIG. 2, the bill management unit 148 can transmit the electronic data file and the combined payments to the insurance carriers 178 or other recipients, such as through a wire transfer to each carrier. In some embodiments, the electronic data file can also include information about nonpayment of escrow bills to notify the insurance carriers 178 of bills that will be delayed or will remain unpaid.

In some exemplary embodiments, the bill management unit 148 can manage other escrow bills, in addition to those from insurance carriers 178. The reporting system 100 can receive various electronic escrow bills, which can be managed and, if appropriate, paid by the bill management unit 148.

As a result of operations of the bill management unit 148, the reporting system 100 can provide a smoother, more streamlined, and less error-prone payment process than provided by conventional methods, while reducing or eliminating the handling of paper checks.

### CONCLUSION

Accordingly, as described above, various embodiments of reporting systems according to the present invention can provide escrow payments status, facilitate escrow payments, detect and provide change in loan information, provide insurance policy status, and process tax bills.

While various exemplary embodiments of reporting systems have been disclosed and illustrated, many modifications, additions, and deletions can be made to the reporting systems without departing from the spirit and scope of the present invention and its equivalents, as set forth in the following claims.

What is claimed is:

1. A reporting system comprising:
a communication device for communicating with financial institutions and insurance carriers;
a computer processor for reconciling data received from the financial institutions and insurance carriers with data stored in a database;
a status update unit for communicating over the communication device to update the financial institutions of changed insurance information related to properties financed by the financial institutions and to update the insurance carriers of changed loan information related to properties insured by the insurance carriers; and
a bill management unit for managing escrow bills to escrow accounts kept by the financial institutions.

2. The reporting system of claim 1, the computer processor being further configured to prepare loss payee notification for transmittal via the communication device.

3. The reporting system of claim 1, the status update unit being further configured to notify a first financial institution of lapsed insurance coverage on a property financed by the first financial institution.

4. The reporting system of claim 1, the bill management unit being further configured to reconcile escrow bills with data stored in the database.

5. The reporting system of claim 1, the bill management unit being further configured to receive escrow bill payments from the financial institutions.

6. The reporting system of claim 5, the bill management unit being further configured to aggregate the received escrow bill payments for a single insurance carrier into a combined wire transfer.

7. A computer program product embodied in a computer-readable medium, the computer program product comprising an algorithm adapted to effectuate a method of reporting information, the method comprising:
receiving a plurality of escrow bills;
receiving a plurality of escrow payments for fulfillment of one or more of the plurality of escrow bills;
grouping the received escrow payments based on their recipients;
producing a combined payment by aggregating together two or more of the received escrow payments that are directed to a first recipient;
producing an electronic file with the details of the two or more aggregated escrow payments; and
transmitting the combined payment and the electronic file to the first recipient.

8. The computer program product of claim 7, the first recipient being an insurance carrier, and the two or more aggregated escrow payments being insurance payments to the insurance carrier.

9. The computer program product of claim 7, the method further comprising determining whether to pay a first escrow bill.

10. The computer program product of claim 9, the method further comprising notifying a biller of nonpayment of the first escrow bill.

11. The computer program product of claim 7, the method further comprising reconciling data in the escrow bills with data in a database.

12. The computer program product of claim 7, the method further comprising determining whether an intended recipient of an escrow payment is the correct recipient of that escrow payment.

13. A computer program product embodied in a computer-readable medium, the computer program product comprising an algorithm adapted to effectuate a method of reporting information, the method comprising:
receiving data related to a first property;
reconciling the received data with initial data stored in a database to determine current data related to the first property;
identifying a customer having an interest in the first property; and
notifying the identified customer of a change in information related to the first property if the current data related to the property differs from the initial data stored in the database.

14. The computer program product of claim 13, the customer being an insurance carrier or a financial institution.

15. The computer program product of claim 13, the method further comprising providing a web interface for the identified customer to retrieve notification of the change in information.

16. The computer program product of claim 15, the customer being a financial institution, and the change in information relating to insurance policy status.

17. The computer program product of claim 13, the method further comprising providing a system-to-system interface for a computing device of a financial institution to retrieve notification of the change in information, wherein the change in information relates to insurance policy status

18. The computer program product of claim 13, the method further comprising transmitting a loss payee notification to a financial institution based on the data received.

19. The computer program product of claim 13, the method further comprising notifying a financial institution of a change in insurance coverage of the property.

20. The computer program product of claim 13, the method further comprising notifying an insurance carrier of a change in loan information related to the property.
